(19) United States
(12) Patent Application Publication
(10) Pub. No.: US 2008/0316490 A1
(43) Pub. Date: Dec. 25, 2008

(54) Planar surface plasmon resonance detector

(75) Inventors: Ta-Jen Yen, Hsinchu County (TW); Chung-Tien Li, Tainan County (TW); Hsin-Yun Chang, Taichung City (TW); You-Lun Guan, Taoyuan County (TW)

Correspondence Address: Joe McKinney Muncy, PO Box 1364, Fairfax, VA, 22038-1364, US

(73) Assignee: National Tsing Hua University

(21) Appl. No.: 11/812,489

(22) Filed: Jun. 19, 2007

(51) Int. Cl. G01N 21/55

(52) U.S. Cl. 356/445

(57) ABSTRACT

The present invention discloses a planar surface plasmon resonance detector, wherein a periodic metallic grating structure is arranged on a common glass substrate to replace prisms and generate surface plasmon resonance. The shift of the wavelength or incident angle for surface plasmon resonance is used to detect biochemical molecules. Further, a low-cost white light-emitting diode replaces laser to function as a light source. Via the metallic grating structure and the white light-emitting diode, the present invention can facilitate a low-cost, compact and portable planar surface plasmon resonance detector and popularize the planar surface plasmon resonance detector.

### FIELD OF THE INVENTION

The present invention relates to a plasmon resonance detector, particularly to a planar surface plasmon resonance detector, which adopts a white light-emitting diode as a light source and replaces prisms with a grating structure to induce surface plasmon resonance.

### BACKGROUND OF THE INVENTION

Surface plasmon resonance is a phenomenon: when a light beam hits on a metallic surface at a specified incident angle, the intensity of the reflected light detected by a light detector is near zero, i.e. the reflectivity is near zero, and the non-reflected light travels along the direction parallel to the interface and induces the so-called surface plasmon resonance (SPR). Surface plasmon resonance is usually induced by an ATR (Attenuated Total Reflection) method, wherein a light beam reaches a metallic film via prisms at an incident angle greater than the total-reflection angle, and the intensity of the reflected light is near zero at a specified angle.

SPR detectors have a high sensitivity and can instantly analyze the interaction between molecules without labeling the inspected molecules. SPR detectors can perform fast, quantitative, parallel and massive inspections. Therefore, SPR detectors have been extensively used in detecting the interactions between biochemical molecules, including the interactions between antigen and antibody, enzyme and ground substance, endocrine and receptor, nucleic acid and nucleic acid. An SPR detector may also cooperate with a biological chip to form a screening platform of a new medicine. Besides, SPR detectors can apply to the field of environmental engineering, such as the detections of gas, chemical substance, wastewater, etc., to perform the surveillance of pollution.

Surface plasmon resonance is a behavior that aggregative electron oscillation occurs in the interface of two materials or a phenomenon that the charges of a metal have aggregative dipolar resonance. However, not all interfaces can have surface plasmon resonance. Generally, surface plasmon resonance only occurs in the interface of two materials respectively having positive and negative dielectric constants, such as the interface of a metal and a dielectric, and the sum of the dielectric constants should be negative. Besides, surface plasmon resonance cannot be induced by injecting a general planar wave on a metal surface but can be induced by the greater wave vector component (kₓ) of the evanescent wave generated by total reflection. The electromagnetic field of surface plasmon resonance has the highest intensity at the interface and vertically enters the medium with the intensity exponentially attenuated. Surface plasmon resonance will not be motivated unless the interface-parallel wave vector component (kₓ) of incident light is equal to the wave vector (kₛₚ) of surface plasmons. In the field of SPR detectors, there are Otto and Kretschmann modes utilizing evanescent wave to induce surface plasmon resonance. The two modes adopt prisms to generate evanescent wave to induce surface plasmon resonance. Such a method is also generally applied to detect biochemical molecules.

In the conventional Kretschmann-mode SPR detector, a metallic film is coated on a prism, and a sample is detected by the system of prism-metallic film-medium containing sample (the air or water solution of the sample). In a U.S. Pat. No. 5,991,488, Salamon et al. disclosed an improved CPWR (Coupled Plasmon-Waveguide Resonance) detector, wherein a dielectric layer is interposed between a metallic film and the sample-containing medium to increase the sensitivity, promote the spectrum analysis ability and absorb/fix the ligand of the sample. Thereby, the prism-type SPR detectors can be more widely used.

At present, there have been many SPR detectors used in the related fields. Some of them adopt high-refractivity prisms to increase the wave vector component (kₓ) of incident light to benefit the generation of surface plasmon resonance or adopt laser or infrared light as the light source. Owing to the high-priced monochromatic light source and the expensive high-refractivity prism glass, the current commercial SPR detectors are not only hard to fabricate and costly but also massive and hard to carry about. Therefore, the conventional SPR detectors still need improving.

### SUMMARY OF THE INVENTION

One objective of the present invention is to provide a planar surface plasmon resonance (SPR) detector, wherein a periodic metallic grating structure is arranged on a common glass substrate to replace prisms to generate surface plasmon resonance, and the shift of the wavelength for surface plasmon resonance is used to detect biochemical molecules, and whereby a low-cost, compact and portable planar SPR detector is achieved.

Another objective of the present invention is to provide a planar SPR detector, wherein a low-cost white light-emitting diode replaces laser to function as a light source to excite surface plasmons of a periodic metallic grating structure on a common glass substrate. Via the metallic grating structure and the white light-emitting diode, the present invention can facilitate a low-cost, compact and portable planar SPR detector and popularize the planar SPR detector.

The planar SPR detector of the present invention comprises a glass substrate, a metallic detection film arranged on the glass substrate, a metallic grating structure on the metallic detection film. The sample-containing liquid (the liquid containing the material to be tested) is disposed on the metallic detection film and the metallic grating structure to generate surface plasmon resonance. The present invention further comprises a light-source generator and a light detector. The light-source generator includes a white light-emitting diode and provides a light source for the metallic grating structure. The light detector receives the light signal reflected by the metallic detection film.

The present invention may further comprise a cover. The cover together with the metallic grating structure forms a covered channel. The microchannel allows the sample-containing liquid having a thickness of tens of microns to pass; thus, the test area is enlarged.

The metallic grating structure is made of gold, silver or copper and has a spacing of between 50 and 500 nm. The metallic grating structure is fabricated with the nano-imprint technology, the E-beam lithography, the UV lithography, the interference lithography, or another nanometric technology.

The metallic detection film is a gold film, a silver film, or a copper film. Alternatively, the metallic detection film may be formed via depositing a gold film over a silver film.

Besides, the present invention may further comprise an adhesive layer between the glass substrate and the metallic detection film. The adhesive layer is an about 3 nm thick film made of titanium, aluminum or chromium. The adhesive layer is used to increase the adhesiveness of the metallic detection film to the glass substrate so that the present invention can be repeatedly used.

### BRIEF DESCRIPTION OF THE DRAWINGS

FIG. 1 is a diagram schematically showing the planar SPR detector according to the present invention.

FIG. 2 is a diagram schematically showing that a sample-containing liquid is disposed on the planar SPR detector according to the present invention.

FIG. 3 is a diagram schematically showing the planar SPR detector according to one embodiment of the present invention.

FIG. 4 is a diagram schematically showing the microchannel design in the planar SPR according to the present invention.

FIG. 5 is a diagram showing the relationship of chromatic dispersion.

FIG. 6 is a diagram showing the relationships between the wavelength and the intensity of reflected light for different samples.

### DETAILED DESCRIPTION OF THE PREFERRED EMBODIMENTS

The technical contents of the present invention will be described in detail with the embodiments. However, it should be noted that the embodiments are only to exemplify the present invention but not to limit the scope of the present invention.

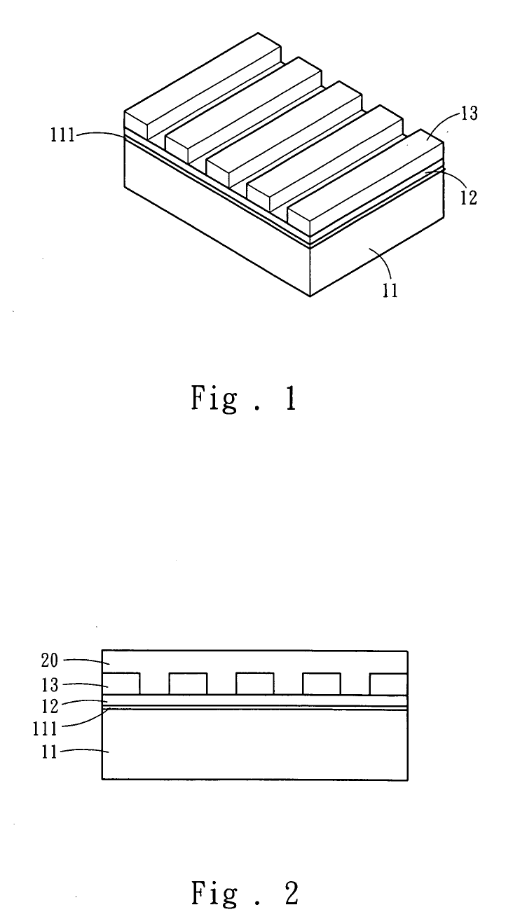

Refer to FIG. 1 a diagram schematically showing the planar SPR detector according to the present invention. The planar SPR detector of the present invention comprises a glass substrate 11, a metallic detection film 12 arranged on the glass substrate 11, a metallic grating structure 13 on the metallic detection film 12. As shown in FIG. 2, a sample-containing liquid 20 (the liquid containing the material to be tested) is disposed on the metallic detection film 11 and the metallic grating structure 13 to generate surface plasmon resonance. The metallic detection film 12 is a gold film, a silver film, or a copper film. Alternatively, the metallic detection film 12 may be formed via depositing a gold film over a silver film. The metallic grating structure 13 is made of gold, silver or copper and has a spacing of between 50 and 500 nm. The metallic grating structure is fabricated with the nano-imprint technology, the E-beam lithography, the UV lithography, the interference lithography or another nanometric technology, which can achieve a precision nanometric structure.

The present invention may further comprise an adhesive layer 111 between the glass substrate 11 and the metallic detection film 12. The adhesive layer 111 is an about 3 nm thick film made of titanium, aluminum or chromium. The adhesive layer 111 is used to increase the adhesiveness of the metallic detection film 12 to the glass substrate 11 so that the present invention can be repeatedly used.

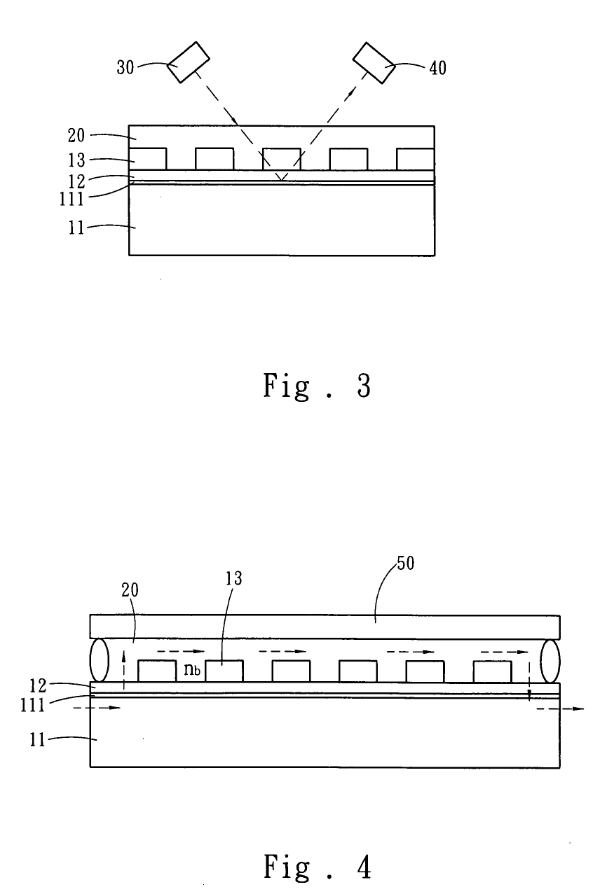

Refer to FIG. 3. The present invention further comprises a light-source generator 30 and a light detector 40. The light-source generator 30 includes a white light-emitting diode and provides a light source for the metallic grating structure 13. The light detector 40 receives the light signal reflected by the metallic detection film 12.

Refer to FIG. 4. The present invention may further comprise a cover 50. The cover 50 together with the metallic grating structure 13 forms a covered channel. The microchannel allows the sample-containing liquid 20 having a thickness of tens of microns to pass; thus, the tested area is enlarged.

A surface plasmon is an electromagnetic wave existing on the interface between a metal and a dielectric or a phenomenon that the charge density of a metal has an aggregative dipolar resonance. The electromagnetic field of surface plasmon wave has the highest intensity on the interface. The electromagnetic field of surface plasmon wave enters a medium along the direction vertical to the interface and is exponentially attenuated in the medium. Surface plasmon wave will not be motivated unless the interface-parallel wave vector component (kₓ) of incident light wave is equal to the wave vector (kₛₚ) of surface plasmons. To achieve the coupling condition, the incident angle and the dielectric constants have to satisfy the following equations:

$${k}_{x} = \frac{ω}{c} sin θ ;$$

$${k}_{sp} = \frac{ω}{c} \sqrt{\frac{{ɛ}_{1} {ɛ}_{2}}{{ɛ}_{1} + {ɛ}_{2}}}$$

wherein ω is the frequency of the incident light, θ the incident angle, ∈₁ the dielectric constant of the dielectric (∈₁>0), and ∈₂ the dielectric constant of the metal (∈₂<0).

As the interface-parallel wave vector component (kₓ) of incident light wave is usually smaller than the wave vector (kₛₚ) of surface plasmons, a grating, a waveguide, or prisms are usually needed to satisfy the condition of inducing surface plasmons.

A grating structure or a periodic ripple is a method to couple surface plasmons, and the following equation of wave vector should be satisfied:

kₛₚ=2π/λ*n_{b} sin(θ)+m×2π/Λ (Equation 1)

wherein n_{b} is the refractive index of the environment, λ the wavelength, Λ the period, m the diffraction order, and kₛₚ the wave vector of surface plasmon resonance.

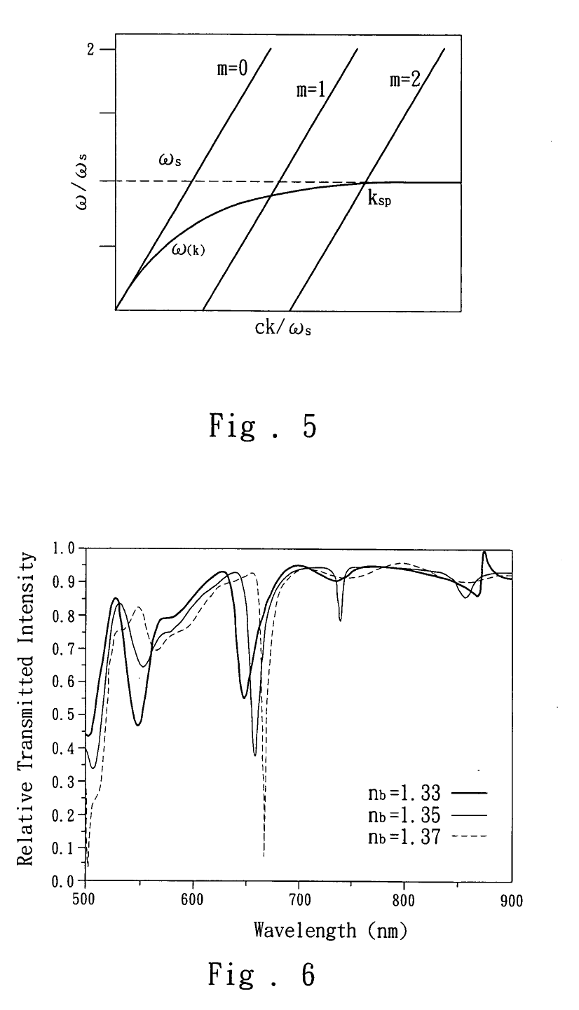

Incident light will not successfully couple surface plasmons unless the wave vector of the incident light matches the wave vector (kₛₚ) of surface plasmons. The periodic structure of the grating provides an enhancing factor (m×2π/Λ). Refer to FIG. 5. From the relationship of chromatic dispersion, it is observed that the curve of incident light moves from left to right and then intersects kₛₚ at one point, which is attributed to the periodic structure. The grating structure can be represented by the following sinusoidal function:

S(x)=h sin(2π/a)x, (a=Λ),

and such an equation can explain the appearance of the enhancing factor.

The present invention utilizes a grating structure to make incident light induce surface plasmon resonance and applies the surface plasmon resonance to the field of biochemical detection. In contrast to the ATR method which utilizes the evanescent wave generated by the total reflection in conventional prisms to induce surface plasmon resonance, the present invention utilizes a periodic grating structure 13 on a metallic detection film 12 to induce surface plasmon resonance and then utilizes the shift of the wavelength for surface plasmon resonance to detect biochemical molecules.

Refer to FIG. 3 again. The light-source generator 30 projects an incident light (with a specified wavelength) on the metallic grating structure 13 from the top side. The incident angle is fixed. The predetermined wavelength of the continuous light can make the continuous metallic detection film 12 and the metallic grating structure 13 generate surface plasmon resonance under the fixed angle. (Please refer to Equation 1.) When surface plasmon resonance occurs, the intensity of the resonant wavelength in continuous light will be greatly reduced, and the light detector 40 will detect such a phenomenon. If the refractive index n_{b} of the environment is changed, it can be known from Equation 1 that the resonant wavelength of the surface plasmon will be changed according to the variation of n_{b}. Refer to FIG. 4 again. The biochemical molecules in the sample-containing liquid 20 flow into the microchannel and react with the micells, which are deposited on the surface beforehand and able to react with a specified molecule. The reaction between a biochemical molecule and the corresponding micells will change the refractive index n_{b} of the environment, and the resonant wavelength λ which can induce surface plasmon resonance will also be changed. The detection of a specified biochemical molecule can thus be realized via observing the shift of the resonant wavelength λ which can induce surface plasmon resonance.

Refer to FIG. 2 again. The refractive index of the sample-containing liquid 20 containing a biochemical molecule is denoted by n, and n_{b} denotes the changed refractive index after the biochemical molecule combines with the micells on the surface. The white light-emitting diode emits a continuous spectrum of incident light with wavelengths ranging from 500 to 900 nm (333 THz-600 THz) to induce surface plasmon resonance.

The period of the metallic grating structure 13 will be varied according to the test environment and the tested molecule. The present invention is verified with the case: the metallic grating structure 13 has a period of 448 nm and a spacing of 224 nm, and the metallic detection film 12 has a thickness of 10 nm. When the sample-containing liquids 20 respectively having refractive indexes n_{b} 1.33, 1.37 and 1.39 flow through the microchannel, the frequency for the surface plasmon resonance will vary.

Refer to FIG. 6. Each downward peak represents a frequency (wavelength) for surface plasmon resonance. It is known from FIG. 6: the frequency for surface plasmon resonance varies with the refractive index, and the peak also shifts correspondingly. Via the shift of the peak (the change of the frequency for surface plasmon resonance), the biochemical detection is thus achieved.

The spirit of the present invention is to replace the conventional prisms with a periodic metallic grating structure, which is arranged on a common glass substrate, to generate surface plasmon resonance and then utilize the shift of the frequency for surface plasmon resonance to detect biochemical molecules. The present invention further replaces the laser light source with a low-cost white light-emitting diode to induce surface plasmon resonance in a periodic metallic grating structure on a common glass substrate. Via the metallic grating structure and the white light-emitting diode, the present invention can facilitate a low-cost, compact and portable planar SPR detector and popularize the planar SPR detector.

Those preferred embodiments described above are only to exemplify the present invention but not to limit the scope of the present invention. Any equivalent modification or variation according to the spirit of the present invention is to be also included within the scope of the present invention.

What is claimed is:

1. A planar surface plasmon resonance detector, comprising the following elements:
a glass substrate;
a metallic detection film arranged on said glass substrate; and
a metallic grating structure arranged on said metallic detection film,
wherein a sample-containing liquid is disposed over said metallic detection film and said metallic grating structure for performing surface plasmon resonance.

2. The planar surface plasmon resonance detector according to claim 1, further comprising a light-source generator providing a light source for said metallic grating structure.

3. The planar surface plasmon resonance detector according to claim 2, wherein said light-source generator further comprises a white light-emitting diode.

4. The planar surface plasmon resonance detector according to claim 1, further comprising a light detector receiving the light signal reflected by said metallic detection film.

5. The planar surface plasmon resonance detector according to claim 1, further comprising a cover used to form a covered channel between said cover and said metallic grating structure.

6. The planar surface plasmon resonance detector according to claim 1, further comprising an adhesive layer arranged between said glass substrate and said metallic detection film and used to increase the adhesiveness of said metallic detection film to said glass substrate.

7. The planar surface plasmon resonance detector according to claim 6, wherein the material of said adhesive layer is selected from the group consisting of titanium, aluminum, and chromium.

8. The planar surface plasmon resonance detector according to claim 1, wherein the material of said metallic grating structure is selected from the group consisting of gold, silver and copper.

9. The planar surface plasmon resonance detector according to claim 1, wherein the spacing of said metallic grating structure is between 50 and 500 nm.

10. The planar surface plasmon resonance detector according to claim 7, wherein said metallic grating structure is fabricated with the nano-imprint technology, the E-beam lithography, the UV lithography, or the interference lithography.

11. The planar surface plasmon resonance detector according to claim 1, wherein said metallic detection film is selected from the group consisting of a gold film, a silver film and a copper film.

12. The planar surface plasmon resonance detector according to claim 1, wherein said metallic detection film is a combination of a gold film and a silver film.

13. The planar surface plasmon resonance detector according to claim 12, wherein said metallic detection film is formed via depositing a gold film on a silver film.
